(19) United States
(12) Patent Application Publication
(10) Pub. No.: US 2017/0272197 A1
(43) Pub. Date: Sep. 21, 2017

(54) Extender For Optical Access Communication Network

(71) Applicant: Telekom Malaysia Berhad, Kuala Lumpur (MY)

(72) Inventors: Asmahanim Binti Ahmad, Kajang (MY); Dedy Tarsono, Bandung (ID); Muhammad Zamzuri bin Abdul Kadir, Kajang (MY); Zulhedry Abdul Manaf, Bandar Baru Bangi (MY)

(73) Assignee: Telekom Malaysia Berhad, Kuala Lumpur (MY)

(21) Appl. No.: 15/432,424

(22) Filed: Feb. 14, 2017

(30) Foreign Application Priority Data
Mar. 17, 2016 (MY) PI 2016000498

(51) Int. Cl. H04J 14/02; H04B 10/291

(52) U.S. Cl. CPC H04J 14/0221; H04B 10/2916; H04J 14/0223; H04J 14/0247

(57) ABSTRACT

The present invention discloses an optical line terminal that includes one or more downstream signal processing means for generating a downstream signal, and converting data of the downstream signal into a serial data; a wavelength division multiplexing means for combining the serial data of different wavelengths together and then performing transmission of the combined signals; and one or more upstream signal processing means for extracting data of an upstream signal from the wavelength division multiplexing means. The terminal includes an extender including a first optical amplifier for amplifying the upstream signal, a second optical amplifier for amplifying the downstream signal, a Raman wavelength division multiplexing module for separating and combining data signal and pump light from Raman pump unit, and a Raman pump unit coupled to the Raman wavelength division multiplexing module to provide Raman amplification to the upstream and downstream signals.

### CROSS-REFERENCE TO RELATED APPLICATIONS

The present application claims the priority benefit of Malaysian Patent Application No. PI 2016000498, filed Mar. 17, 2016, which is incorporated by reference in its entirety.

### FIELD OF INVENTION

The invention relates to telecommunications. More particularly, the invention relates to an extender for optical access networking.

### BACKGROUND OF THE INVENTION

A passive optical network (PON) is a point-to-multipoint, fiber-to-the-premises, broadband network architecture in which unpowered (“passive”) optical splitters are used to enable a single optical fiber to serve multiple customer premise locations. Conventionally, a PON includes an optical line terminal (OLT) at a service provider's central office (CO) and a multiplicity of optical network units or terminals (ONUs or ONTs, hereinafter referred to as “ONUs”) located at or in the vicinity of end users. The OLT is linked to the plurality ONUs via an optical distribution network (ODN) which is outside of the network provider's plant. The ODN typically includes a transmission optical fiber that terminates at a 1:N passive optical splitter located in relatively close proximity to ONUs.

The main drawbacks of PON are that the reach and splitting ratio of a PON is limited by the optical signal losses and strength. In order to increase the signal travelling distance and the splitting ratio, a reach extender is provided. There are a few patented technologies over the prior art relating to the aforementioned extender. Of interest in respect to a point to multipoint optical-electrical-optical extender for a PON is EP2503712A1, which is incorporated herein by reference. EP2503712A1 discloses an extender including a point-to-point optical-electrical-optical converter adapted to amplify an optical downlink feeder signal on a feeder optical transmission channel on a downlink from an optical line terminal to a plurality of optical network terminals, thereby yielding the amplified optical downlink feeder signal; and a multipoint-to-point optical-electrical-optical converter adapted to amplify a plurality of optical uplink drop signals on an uplink from the plurality of optical network terminals to the optical line terminal.

Another a passive optical network reach extender based on a wavelength tunable optical module is disclosed in US20140186043A1, which is incorporated herein by reference. US20140186043A1 provides a passive optical network reach extender including a first optical splitter configured to receive an optical signal from an optical line terminal and split the signal into optical signals having a multiplexed wavelength, a wavelength tunable remote relay configured to receive the optical signals split from the first optical splitter, and select and control an available wavelength for each port, a wavelength multiplexer configured to multiplex a wavelength of the optical signal output from the wavelength tunable remote relay, and a second optical splitter configured to split the optical signal multiplexed by the wavelength multiplexer into a plurality of optical network units.

The existing systems tend to use an inline optical amplifier in the ODN to boost the optical signal. To adopt such approach, proper modifications such as the implementation of relevant electrical modules and cooling system on the PON fiber distribution cabinets (FDC) are needed and this will increase the cost of the PON system. Furthermore, the ONUs side should always remain simple to minimize the cost of the ONUs as the customers are usually residential users. However, the approach will complicate the architecture of the ONUs, which is unfavourable. In addition to that, the use of Optical-Electrical-Optical design in the prior system limits their transmission rate. Therefore, a need exists for the extender to be arranged in a manner such that the ONUs and the FDCs can preserve a “passive” ODN to ultimately reduce the cost of the PON system.

### SUMMARY OF INVENTION

The invention provides an optical line terminal including one or more downstream signal processing means for generating a downstream signal, and converting data of the downstream signal into a serial data, a wavelength division multiplexing means for combining the serial data of different wavelengths and transmitting the combined signals, and one or more upstream signal processing means for extracting data of an upstream signal from the wavelength division multiplexing means. The terminal includes an extender which includes a first optical amplifier for amplifying the upstream signal, a second optical amplifier for amplifying the downstream signal, a Raman wavelength division multiplexing module for separating and combining data signal and pump light from a Raman pump unit, and the Raman pump unit coupled to the Raman wavelength division multiplexing module to provide Raman amplification to the upstream and downstream signals. The extender may include one or more optical couplers to couple the upstream and downstream signals. The optical couplers can include a band separation wavelength division multiplexing or optical circulator that separates and combines the upstream and downstream signals.

The Raman wavelength division combines the Raman pump light into the optical transmission line and it further separates and/or prevents the Raman light from going to the discrete upstream or downstream optical amplifier.

The optical line terminal is configured to provide a service using signals of different wavelengths in a Time Division Multiplexing scheme.

In one embodiment of the invention, the optical line terminal includes a control unit for controlling the upstream and downstream signals and network protocol.

At least one of the preceding objects is met, in whole or in part, by the present invention, in which the embodiment of the present invention describes a passive optical network including an optical distribution network, one or more optical network units configured to receive downstream signals and upload upstream signals via the optical distribution network, and an optical line terminal in communication with the optical distribution network including one or more downstream signal processing means for generating a downstream signal, and converting data of the downstream signal into a serial data, a wavelength division multiplexing means for combining the serial data of different wavelengths and transmitting the combined signals, and one or more upstream signal processing means for extracting data of an upstream signal from the wavelength division multiplexing means. The terminal includes an extender including a first optical amplifier for amplifying the upstream signal, a second optical amplifier for amplifying the downstream signal, a Raman wavelength division multiplexing module for separating and combining data signal and pump light from a Raman pump unit, and the Raman pump unit coupled to the Raman wavelength division multiplexing module to provide Raman amplification to the upstream and downstream signals.

The optical distribution network includes one or more optical passive splitters for splitting the signals evenly.

Advantageously, the optical line terminal is configured to provide a service using signals of different wavelengths in Time Division Multiplexing scheme. The terminal may include a control unit for controlling the upstream and downstream signals and network protocol.

In another one embodiment of the invention, the extender includes one or more optical couplers to couple the upstream and downstream signals.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a schematic diagram of a passive optical network system which embodies therein the principle features of the invention.

### DETAILED DESCRIPTION OF THE INVENTION

The invention will now be described in greater detail, by way of example, with reference to the drawings.

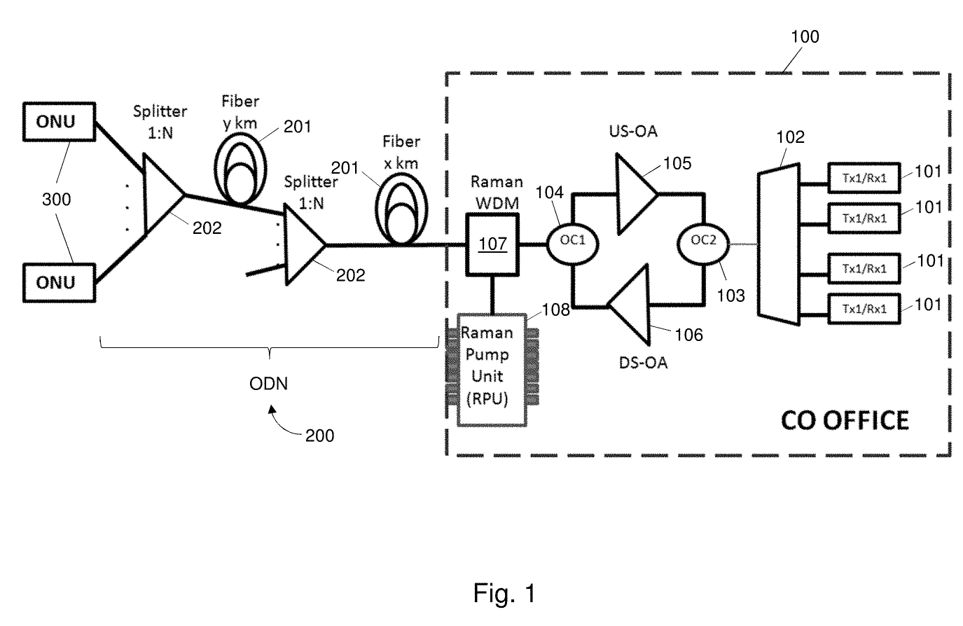

FIG. 1 illustrates an exemplary passive optical network (PON) system formed in accordance with preferred embodiments of the invention. The PON system includes an optical line terminal (OLT) 100 configured to provide a service using an optical signal of a different wavelength in Time Division Multiplexing scheme, a plurality of optical network units (ONUs) 300 configured to utilizes the service that is provided by the OLT 100, and an optical distribution network (ODN) 200 configured to transmit downstream optical signals from the OLT 100 to the ONUs 300 and transmit upstream optical signals from the ONUs 300 to the OLT 100. The PON is preferably a time wavelength division multiplexing-passive optical network (TWDM-PON). The mentioned service can include voice service or voice over IP, network data, picture, and video. The ODN 200 is a section sandwiched between the OLT 100 and ONUs 300, and includes one or more single mode optical fibre transmission lines 201, one or more optical splitters 202, and one or more fibre distribution cabinets, duplexed to enable upstream and downstream signals to share the same fibre 201 on separate wavelengths.

In the preferred embodiment of the invention, the OLT 100 includes a plurality of transceivers 101 for receiving and extracting data from the upstream signals, generating the downstream signals containing the service data in response to the upstream signals, a wavelength division multiplexing module 102 for performing a wavelength division multiplexing functions, a control unit for generating variables and timing singles used for controlling the operation of the transceivers 101 and performing a network control protocol, an extender configured to compensate losses that originate from the optical fibre transmission line 201 and to increase the upstream and downstream signal travelling distance and the splitting ratio by pre-amplifying and amplifying the upstream and downstream signals respectively. The extender includes one or more optical couplers 103, 104 to couple the upstream and downstream signals, a first optical amplifier 105 for pre-amplifying the upstream signals, a second optical amplifier 106 for amplifying the downstream signals, a Raman wavelength division multiplexing module 107 for separating and combining data signal and pump light from a Raman pump unit 108, and the Raman pump unit 108 coupled to the Raman wavelength division multiplexing module 107 to provide Raman amplification to the upstream and downstream signals so that better optical signal-to-noise ratio (OSNR) can be achieved.

The present disclosure includes that contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

1. An optical line terminal, comprising:
one or more downstream signal processing means for generating a downstream signal and converting data of the downstream signal into serial data;
a wavelength division multiplexing means for combining the serial data of different wavelengths together and transmitting the combined signals;
one or more upstream signal processing means for extracting data of an upstream signal from the wavelength division multiplexing means; and
an extender including:
a first optical amplifier for amplifying the upstream signal;
a second optical amplifier for amplifying the downstream signal;
a Raman wavelength division multiplexing module for separating and combining a data signal and a pump light from a Raman pump unit; and
the Raman pump unit coupled to the Raman wavelength division multiplexing module to provide Raman amplification to the upstream and downstream signals.

2. The optical line terminal according to claim 1, wherein the optical line terminal is configured to provide a service using signals of different wavelengths in a Time Division Multiplexing scheme.

3. The optical line terminal according to claim 1, wherein the extender comprises one or more optical couplers to couple the upstream and downstream signals.

4. The optical line terminal according to claim 1, comprising a control unit for controlling the upstream and downstream signals and a network protocol.

5. A passive optical network comprising:
an optical distribution network;
one or more optical network units configured to receive downstream signals and upload upstream signals via the optical distribution network; and
an optical line terminal in communication with the optical distribution network, the optical line terminal including:
one or more downstream signal processing means for generating a downstream signal and converting data of the downstream signal into serial data;
a wavelength division multiplexing means for combining the serial data of different wavelengths together and transmitting the combined signals;
one or more upstream signal processing means for extracting data of an upstream signal from the wavelength division multiplexing means; and
an extender including:
a first optical amplifier for amplifying the upstream signal;
a second optical amplifier for amplifying the downstream signal;
a Raman wavelength division multiplexing module for separating and combining data signal and pump light from Raman pump unit; and
a Raman pump unit coupled to the Raman wavelength division multiplexing module to provide Raman amplification to the upstream and downstream signals.

6. The passive optical network according to claim 5,
wherein the optical distribution network includes one or more optical passive splitters for splitting the signals evenly.

7. The passive optical network according to claim 5, wherein the optical line terminal is configured to provide a service using signals of different wavelengths in a Time Division Multiplexing scheme.

8. The passive optical network according to claim 5, wherein the extender comprises one or more optical couplers to couple the upstream and downstream signals.

9. The passive optical network according to claim 5, wherein the optical line terminal further comprises a control unit for controlling the upstream and downstream signals and network protocol.

10. A method of operating an optical line terminal, comprising:
generating a downstream signal and converting data of the downstream signal into serial data with one or more downstream signal processing means;
combining the serial data of different wavelengths together and transmitting the combined signals with a wavelength division multiplexing means;
extracting data of an upstream signal from the wavelength division multiplexing means with one or more upstream signal processing means;
amplifying the upstream signal with a first optical amplifier of an extender;
amplifying the downstream signal with a second optical amplifier of the extender;
separating and combining a data signal and a pump light from a Raman pump unit with a Raman wavelength division multiplexing module of the extender; and
providing Raman amplification to the upstream and downstream signals with the Raman pump unit, the Raman pump unit coupled to the Raman wavelength division multiplexing module.

11. The method of claim 10, comprising providing a service using signals of different wavelengths in a Time Division Multiplexing scheme with the optical line terminal.

12. The method of claim 10, comprising coupling the upstream and downstream signals with one or more optical couplers of the extender.

13. The method of claim 10, comprising controlling the upstream and downstream signals and a network protocol with a control unit.

14. A method of operating a passive optical network, comprising:
providing an optical distribution network;
receiving downstream signals and upload upstream signals with one or more optical network units via the optical distribution network;
providing an optical line terminal in communication with the optical distribution network;
generating a downstream signal and converting data of the downstream signal into serial data with one or more downstream signal processing means;
combining the serial data of different wavelengths together and transmitting the combined signals with a wavelength division multiplexing means;
extracting data of an upstream signal from the wavelength division multiplexing means with one or more upstream signal processing means;
amplifying the upstream signal with a first optical amplifier of an extender;
amplifying the downstream signal with a second optical amplifier of the extender;
separating and combining a data signal and a pump light from a Raman pump unit with a Raman wavelength division multiplexing module of the extender; and
providing Raman amplification to the upstream and downstream signals with the Raman pump unit, the Raman pump unit coupled to the Raman wavelength division multiplexing module.

15. The method of claim 14, comprising splitting the signals evenly with one or more optical passive splitters of the optical distribution network.

16. The method of claim 14, comprising providing a service using signals of different wavelengths in a Time Division Multiplexing scheme with the optical line terminal.

17. The method of claim 14, comprising coupling the upstream and downstream signals with one or more optical couplers of the extender.

18. The method of claim 14, comprising controlling the upstream and downstream signals and a network protocol with a control unit of the optical line terminal.
